(19) United States
(12) Patent Application Publication
(10) Pub. No.: US 2016/0197633 A1
(43) Pub. Date: Jul. 7, 2016

(54) ORNAMENTAL CARRYING DEVICE

(71) Applicant: Jennifer Noel Nye, Vero Beach, FL (US)

(72) Inventor: Jennifer Noel Nye, Vero Beach, FL (US)

(21) Appl. No.: 14/588,862

(22) Filed: Jan. 2, 2015

(51) Int. Cl. H04B 1/3888; A45F 5/00

(52) U.S. Cl. CPC H04B 1/3888; A45F 5/00; A45F 2005/006

(57) ABSTRACT

An ornamental carrying device joins with a communication system to carry and display the communication system on the body for aesthetic display and facilitated access of the communication system. The device provides an attractive and convenient device for hands-free carrying and operation of a communication system. The device supports the communication system from a portion of the body, such as the neck. A cover portion partially covers the communication system. An anchor surface engages the communication system. An ornament surface displays an ornamental image from the cover. A strap, such as a necklace, wraps around the neck or body part. The strap has free ends that detachably join with the cover portion at anchor points. The strap includes a decorative portion. The decorative portion creates a decorative effect contiguous with the ornamental image.

### CROSS-REFERENCE TO RELATED APPLICATIONS

Not applicable.

### RELATED CO-PENDING U.S. PATENT APPLICATIONS

Not Applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to an ornamental carrying device. More particularly, the invention relates to an ornamental carrying device that retains a communication system to carry and display the communication system on the body for aesthetic display and facilitated access.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that mobile phone accessories include any hardware or software that is not integral to the operation of a mobile phone as designed by the manufacturer.

Typically, the accessories include a phone case that partially covers the phone. The phone case often has decorative features, images, and text. Additional accessories include ornamental embellishments, straps, and colored films. These serve to decorate and personalize the phone. The newest trend in cell phone accessories are skins and design covers, for the dual purpose of protection and personalization.

It is well known that jewelry is a small decorative items worn for personal adornment, such as brooches, rings, necklaces, earrings, and bracelets. Jewelry may be attached to the body or the clothes. Colored stones, precious metals, and diamonds, and synthetic rhinestones are combined to form the decorative effect of jewelry.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a frontal view of an exemplary ornamental carrying device retaining an exemplary communication system from an ornament surface, in accordance with an embodiment of the present invention;

FIG. 2 illustrates a rear view of an exemplary ornamental carrying device retaining an exemplary communication system from an anchor surface, in accordance with an embodiment of the present invention; and

FIG. 3 illustrates a close-up front view of an exemplary ornamental image on an exemplary ornamental side of the cover portion, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of objects does not imply that any or all of the objects are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of carrying devices for holding and accessing a communication apparatus that may be provided by preferred embodiments of the present invention. In one embodiment of the present invention, an ornamental carrying device joins with a communication system to carry and display the communication system on the body for aesthetic display and facilitated access of the communication system. In one embodiment, the device provides an attractive and convenient device for hands-free carrying and operation of a communication system. The device provides the hands-free carrying capacity by joining the communication system with a portion of the body, including, without limitation, a neck, a chest, a crown, a wrist, an arm, and an ankle. The communication system may include, without limitation, a smart phone, telephone, a radio, and a tablet.

The device may cover and protect the communication system while carrying it. This covering capacity serves a plurality of functions, including, without limitation, protecting the device, displaying ornamental features, and visibly supporting the communication system from a portion of the body. While being carried, the device may simultaneously display decorative images, jewelry, and illuminations to create an ornamental effect on and near the communication system.

In some embodiments, the device comprises a cover portion configured to at least partially cover the communication system. The cover portion may at least partially encapsulate the communication system to form a snug fit thereto. In one embodiment, the cover portion comprises a phone case. Numerous differently sized and dimensioned cover portions may be used, whereby each cover portion is configured to cover a specific type of communication system.

The cover portion may be defined by an anchor surface and an opposite ornament surface. A pair of lateral edges extend along the length of the cover portion. The anchor surface provides functionality, while the ornament surface serves as a decorative effect. In some embodiments, the anchor surface may engage and form a secure attachment with the communication system. The communication system may fasten to the anchor surface through frictional forces. Additionally, the anchor surface may have a curved periphery that partially wraps around one side of the communication system to form a more secure attachment.

In some embodiments, the pair of lateral edges or the anchor surface of the cover portion may provide at least one anchor portion for joining the cover portion with a strap. For example, without limitation, the lateral edges or the anchor portion may include a pair of apertures or slots configured to receive free ends of the strap. The cover portion may also include an ornament surface configured to display an ornamental image. In one embodiment, the ornament surface orients away from the body to display the ornamental image. The ornamental image may include a static cling having an image of jewelry or other decorative feature.

In some embodiments, the device may comprise a strap configured to by operable to engage a portion of the body from one end, and join with the cover portion from at least one free end portion. The at least one free end portion may be configured to join with the at least one anchor portion on the cover portion. In one embodiment, the free end portion comprises two free ends with each free end having a jewelry chocker clamp. The free ends may loop around the neck and attach at two anchor portions, such as apertures, on the cover portion. In one embodiment, the strap is a decorative metal chain configured to at least partially wrap around the neck, the wrist, or the ankle. However, the strap may also include, without limitation, a rope, a ribbon, a chain metal, and an elongated bracket.

In keeping with the theme of the ornamental carrying device, the strap may also have an ornamental feature in addition to the functional aspect discussed above. In some embodiments, the strap may include at least one decorative portion. The decorative portion may provide additional ornamental features to the carrying device and the communication system. For example, without limitation, the at least one decorative portion may include a series of evenly-spaced colored stones that join along the length of the strap. However, the decorative portion may be inherent in the strap, such as a chain having a gold composition.

The at least one decorative portion may be configured to create a decorative effect contiguous with the ornamental image. In one embodiment, the strap aligns with the ornamental image of on the ornament surface on the cover portion. In this manner, an illusion of one continuous decorative strap forms, as the strap integrates with the graphical ornamental image on the cover portion.

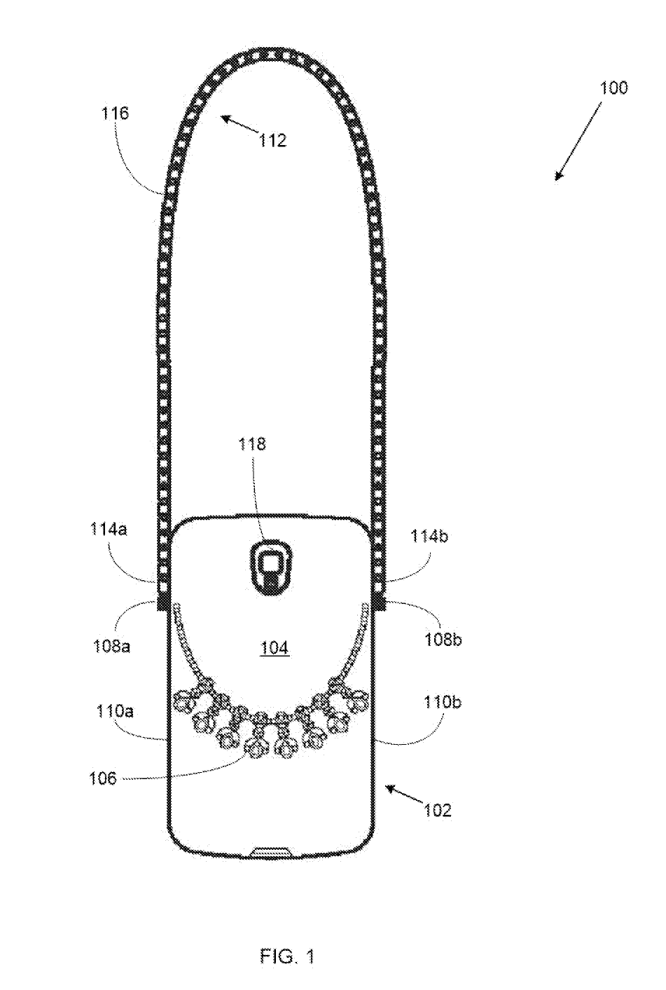

FIG. 1 illustrates a frontal view of an exemplary ornamental carrying device retaining an exemplary communication system from an ornament surface, in accordance with an embodiment of the present invention. In one aspect, an ornamental carrying device 100 joins with a communication system to carry and display a communication system 118 on the body for aesthetic display and facilitated access of the communication system. The communication system may include, without limitation, a smart phone, telephone, a walkie-talkie, a beeper, a radio, and a tablet. In one embodiment, the carrying device joins with a flip-style phone.

Those skilled in the art will recognize that the device provides an attractive and convenient device for hands-free carrying of a smart phone. The device is configured to provide hands-free carrying capacity by engaging the communication system with a section of the body, including, without limitation, a neck, a chest, a crown, a wrist, an arm, and an ankle. In one embodiment, the device forms a necklace that wraps around the neck to support the communication device. In this example, once supported by the necklace, the communication device may rest below the navel for facilitated access and optimal visibility.

In some embodiments, the device may cover and protect the communication system with a cover portion 102. The cover portion may serve to at least partially cover the communication system. In one embodiment, the cover portion at least partially encapsulates the communication system. This covering capacity serves a plurality of functions, including, without limitation, protecting the device, displaying ornamental features, and joining with a portion of the device that is supported by the body. For example, without limitation, the cover portion may cover a back side of a phone, leaving a front side display and camera lens uncovered for functional use of the phone. In one embodiment, the cover portion comprises a phone case. Numerous differently sized and dimensioned cover portions may be used, whereby each cover portion covers a specific communication system.

The cover portion may be defined by an anchor surface and an opposite ornament surface 104. A pair of lateral edges 110a, 110b extend along the length of the cover portion. The anchor surface provides functionality, while the ornament surface creates a decorative effect for the communication system. Suitable materials for the cover portion may include, without limitation, thermoplastic polyurethane, rubber, a rigid polymer, metal, silicon, and wood.

In some embodiments, an anchor surface may engage and form a secure attachment with the communication system. The communication system may fasten to the anchor surface through frictional forces. Additionally, the anchor surface may have a curved periphery that partially wraps around one side of the communication system to form a more secure attachment. In some embodiments, chains and/or clasps provide additional fasteners to lock the communication system with the anchor surface.

In some embodiments, either the pair of lateral edges or the anchor surface of the cover portion may provide at least one anchor portion 108a, 108b for joining with a strap. It is significant to note that because the strap attaches from the lateral edges, the ornamental surface remains free to display ornamental images. The at least one anchor portion may include a pair of apertures or slots configured to receive free ends of the strap. In one embodiment, a right lateral edge is labeled with a U, and a left lateral edge is labeled with a P for labeling and advertising purposes.

While covering and carrying the communication system, the device may simultaneously display decorative images, jewelry, and illuminations to create an ornamental effect for the communication system while it is being carried. The cover portion may include an ornament surface configured to display an ornamental image 106. In one embodiment, the ornament surface orients away from the body so as to display the ornamental image. In some embodiments, the ornamental image may include a static cling that displays an image of jewelry or other decorative feature from the ornamental surface. The cling may include a flat graphic of magazine quality. The ornamental image may form an optical illusion of a continuation of the strap.

The device may comprise a strap 112 configured to engage a portion of the body by at least partially wrapping around the body portion, and also join with the cover portion from at least one free end portion 114a, 114b. The at least one free end portion may be configured to form a secure, yet detachable connection with the at least one anchor portion on the cover portion. In one embodiment, the free end portion comprises two free ends with each free end having a jewelry chocker clamp or a spring ring clasp. However, in other embodiments, additional fasteners known in the art of jewelry may be used.

In one embodiment, two free ends that make up the free end portion may loop around the neck and attach at two anchor portions on the lateral edges of the cover portion, such as apertures. In one possible embodiment, each free end is permanently attached to the integral loop of a typical jewelry chocker clamp or hook or clasp with a movable link. This design could be worn strictly as a necklace when desired by putting it over one's head. This design may also offer a very rapid attachment to a flip-style phone.

In one embodiment, the strap may include a decorative metal chain configured to at least partially wrap around the neck, the wrist, or the ankle. In another embodiment, the strap is an 18-36″ necklace. The chain may be gold or silver plated and have hypoallergenic properties. However, the strap may also include, without limitation, a rope, a ribbon, a chain metal, and an elongated bracket.

The strap may include at least one decorative portion 116 to provide an additional decorative effect to the device. Those skilled in the art, in light of the present teachings, will recognize that a decorative necklace of any desired design can be used, but it must be sufficiently long enough to fit over the wearer's head.

In one embodiment of possible uses, the device may attach a chain or a wearable neck accessory to a communication system, such as a flip style phone. The device may serve to hold the flip-style phone securely from a cover portion while also allowing the flip-style phone to behave like an ornamental neckwear. In essence, the device forms a quick-release carrier for the flip-style mobile phone.

In some embodiments, the carrying device may provide a flexible decorative strap of sufficient length to pass over the head and around the neck. In this example, the free ends of the strap connect to integral loops on a pair of jewelry chocker clamps, hook, or clasps. From this position, the necklace may convert to a cell phone holder by clamping the flexible strap under a hinge between the body and flip top of a flip-style cell phone.

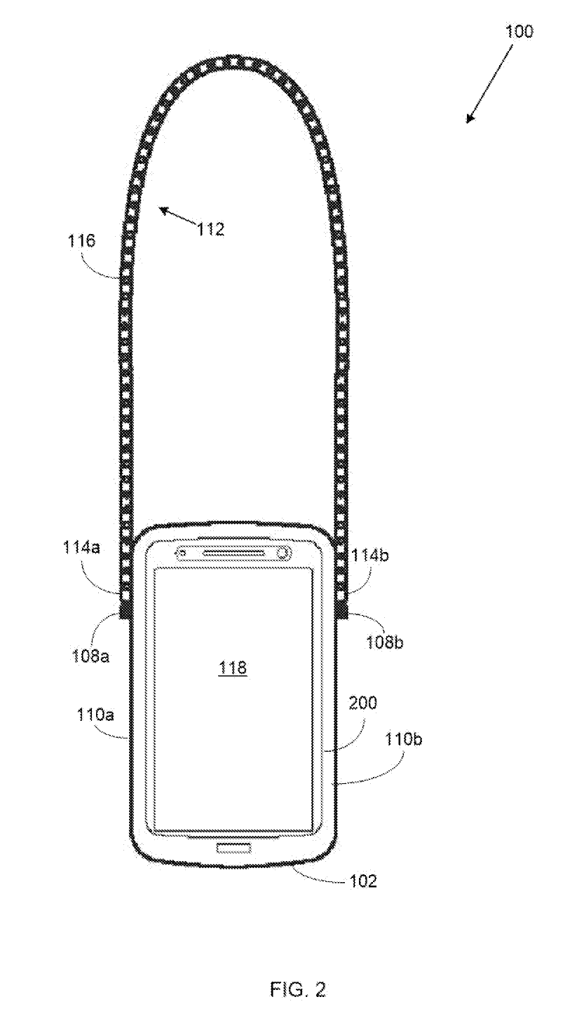

FIG. 2 illustrates a rear view of an exemplary ornamental carrying device retaining an exemplary communication system from an anchor surface, in accordance with an embodiment of the present invention. In one aspect, an anchor surface 200 may engage and form a secure attachment with the communication system. The anchor surface is opposite the ornament surface, and serves chiefly to provide the function of retaining the communication system. In one embodiment, the communication system fastens to the anchor surface through frictional forces. In some embodiments, the anchor surface may have a curved periphery that partially wraps around one side of the communication system to form a more secure attachment. However, any number of fastening mechanisms may be used on the anchor portion, including, without limitation, adhesives, screws, bolts, cables, and magnets. In one alternative embodiment, the anchor portion may include a rechargeable battery.

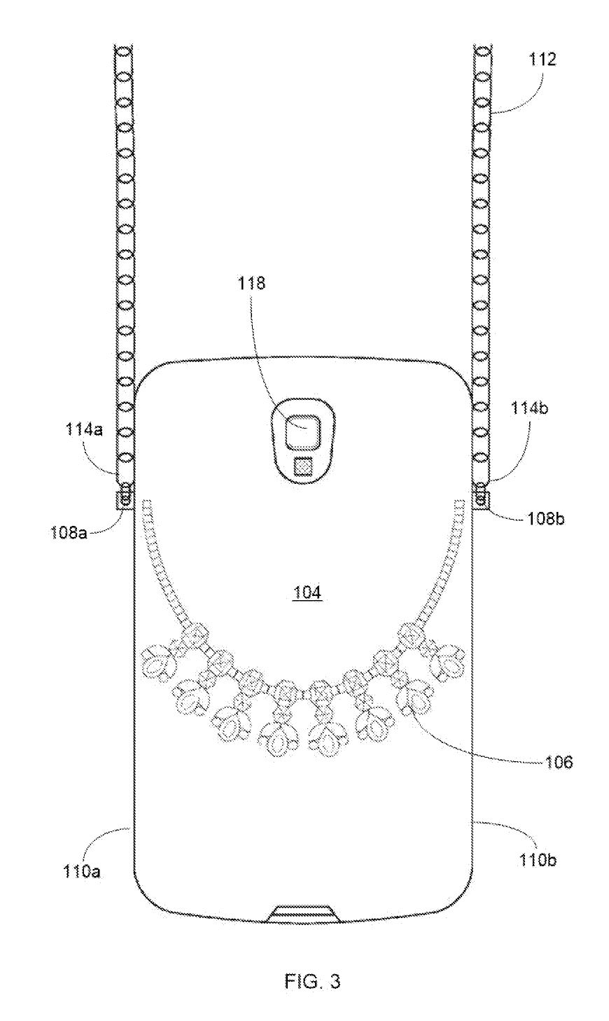

FIG. 3 illustrates a close-up front view of an exemplary ornamental image on an exemplary ornamental side of the cover portion. In one aspect, the strap may provide additional aesthetics to both the carrying device and the communication system. In keeping with the theme of the ornamental carrying device, the strap may have an ornamental feature in addition to the functional aspect discussed above. In some embodiments, the strap may include at least one decorative portion. The decorative portion may provide additional ornamental features to the carrying device and the communication system.

In one embodiment, without limitation, the at least one decorative portion may include a series of evenly-spaced colored stones that join along the length of the strap. However, the decorative portion may be inherently integrated into the strap, such as a chain fabricated from gold. The at least one decorative portion may be configured to create a decorative effect contiguous with the ornamental image. For example, without limitation, the strap aligns with the ornamental image of on the ornament surface on the cover portion. In this manner, an illusion of one continuous decorative strap forms, as the strap graphically integrates with the ornamental image on the cover portion.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a barrier to restrict objects from passing through openings in support objects according to the present invention will be apparent to those skilled in the art. Various aspects of the invention have been described above by way of illustration, and the specific embodiments disclosed are not intended to limit the invention to the particular forms disclosed. The particular implementation of the barrier to restrict objects from passing through openings in support objects may vary depending upon the particular context or application. By way of example, and not limitation, the barrier to restrict objects from passing through openings in support objects described in the foregoing were principally directed to an inflatable barrier that blocks objects from rolling or being inadvertently moved beneath a sofa implementations; however, similar techniques may instead be applied to blocking objects from passing through crevices under factory machines, fryers, and desks in offices, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
a cover portion being configured to at least partially cover a communication system, said cover portion comprising an anchor surface, said anchor surface being configured to engage said communication system, said cover portion further comprising an ornament surface, said ornament surface being configured to display an ornamental image, said cover portion further comprising a pair of lateral edges, each lateral edge comprising at least one anchor portion; and
a strap comprising at least one free end portion, said at least one free end portion being configured to join with said at least one anchor portion, at least a portion of said strap being configured to be operable to engage a portion of a body, said strap further comprising at least one decorative portion, said at least one decorative portion being configured to create a decorative effect contiguous with said ornamental image.

2. The device of claim 1, in which said cover portion comprises a phone case.

3. The device of claim 2, in which said communication system comprises a flip-style phone.

4. The device of claim 3, wherein said cover portion has a substantially rectangular shape.

5. The device of claim 4, wherein said anchor surface is configured to frictionally fasten to said communication system.

6. The device of claim 5, in which said ornament surface comprises a static cling.

7. The device of claim 6, wherein said static cling comprises said ornamental image.

8. The device of claim 7, in which said ornamental image comprises a portion of a necklace.

9. The device of claim 8, in which said at least one anchor portion comprises an aperture.

10. The device of claim 9, in which said strap comprises a necklace.

11. The device of claim 10, wherein said necklace is about 18 to 36 inches long.

12. The device of claim 11, in which said at least one free end comprises a spring ring clasp.

13. The device of claim 12, wherein said at least a portion of said strap is configured to be operable to wrap around the neck.

14. The device of claim 13, in which said at least one decorative portion comprises colored stones.

15. A device comprising:
means for at least partially covering a communication system;
means for enabling said covering means to form attachment means;
means for joining said covering means with at least a portion of a body, said joining means being able to at least partially wrapping around said portion of said body, said joining means further being able to anchor to said covering means; and
means for creating an ornamental effect on said covering means and said joining means.

16. The device of claim 15, in which said communication covering means has a generally rectangular shape.

17. The device of claim 16, further containing means for operating said communication system.

18. The device of claim 17, in which said joining means has a length of about 18 to 36 inches.

19. The device of claim 18, further containing means for detaching said joining means from said communication system.

20. A device consisting of:
a cover portion being configured to at least partially cover a communication system, said cover portion comprising a generally rectangular shape, said communication system comprising a flip-style phone, said cover portion comprising an anchor surface, said anchor surface being configured to engage said communication system, said cover portion further comprising an ornament surface, said ornament surface being configured to display an ornamental image, said ornamental image comprising an image of a necklace, said cover portion further comprising a pair of lateral edges, each lateral edge comprising at least one anchor portion; and
a strap comprising at least one free end portion, said strap comprising a necklace, said at least one free end portion being configured to join with said at least one anchor portion, at least a portion of said strap being configured to be operable to engage a portion of a body, said strap further comprising at least one decorative portion, said at least one decorative portion comprising a plurality of colored stones, said at least one decorative portion being configured to create a decorative effect contiguous with said ornamental image.
